(19) United States
(12) Patent Application Publication
(10) Pub. No.: US 2010/0005402 A1
(43) Pub. Date: Jan. 7, 2010

(54) System and Apparatus for Whispering in Group Chats

(75) Inventors: David A. George, Somers, NY (US); Raymond B. Jennings, III, Ossining, NY (US); Malgorzata E. Stys, Purdys, NY (US)

Correspondence Address: GEORGE A. WILLINGHAN, III;AUGUST LAW, LLC, P.O. BOX 19080, BALTIMORE, MD, 21284-9080, US

(73) Assignee: INTERNATIONAL BUSINESS MACHINES CORPORATION, Armonk, NY (US)

(21) Appl. No.: 12/165,706

(22) Filed: Jul. 1, 2008

(51) Int. Cl. G06F 3/048

(52) U.S. Cl. 715/758

(57) ABSTRACT

A method, system and program storage device are provided for allowing chat room participants to communicate with other participants privately without requiring general chat “friends” or “buddies” pre-authorization. All chatting dialog including private and public chats are consolidated into a unified group chat dialog window that requires no special handling by a user to see public and private chats. The private and public chat messages are displayed chronologically in a single chat message log within the chat group window.

### FIELD OF THE INVENTION

The present invention relates to online group chatting including chat rooms and similar means for at least three persons to share a common, logged, dialog.

### BACKGROUND OF THE INVENTION

Computer or network based team rooms and group chats serve a social interaction function and are commonly used in business settings. For example, a group chat is used for a meeting where the meeting attendees share a group chat dialog. Each participant is provided with a graphical interface for the group chat. This interface appears on a given participants computer monitor and includes a listing of all the current participants in the group chat by name or alias, a chronological display of the chat entries with an associated time stamp and participant identification and a box to submit a chat entry. The group chats can be used to provide a peer-to-peer communication among a group of participants or to deliver a presentation from a single presenter to a group of participants.

A given person can participate simultaneously in two or more group chats. Each chat is displayed as a separate chat window. Multiple chat windows, however, can be difficult to manage or distracting and limits the size of any single chat window. Screen space and distractions are of particular concern when the chat group is used to deliver a presentation to a group of recipients. Therefore in the presentation mode, the presenter keeps only the group chat window open to conserve screen space and to avoid distractions, suppressing the occurrence of other dialogs during the group chat presentation session. An attendee of the group chat may want to provide a private comment or response to the presenter or to a select portion of the other participants. Current group chat systems require participants to invoke a separate dialog with correspondingly separate windows on each client for each separate chat group, even if the new chat group is a subset of the current chat group.

During a presentation, in particular when the chat group is used in conjunction with a live audio presentation, additional chat windows are distracting and disconcerting to the speaker. In addition, the confusion of separate pop-up chats appearing on a screen and obliterating the visible presentation area negatively impacts a presentation. Since chat systems often require users to register one another for one-on-one chatting, a message directed to another participant in the group chat requires establishing a registration between the sender and that other participant. Although the requirement of registration averts possible intrusion by one individual on others, this requirement also impedes communication within sub-sets of participants on the group topic without including others.

### SUMMARY OF THE INVENTION

Systems and methods in accordance with the present invention allow chat group members or chat group participants to converse privately with one another within subsets of the total group of participants. These subsets include one-to-one chats and one-to-sub-group chats that operate concurrently with the group chat involving all of the participants. After a group chat has been established among a plurality of participants, a sub-set or sub-group of those participants is identified. For example, one of the current participants of the group chat identifies a sub-group of participants for a private chat. The sub-group of participants can be identified using the same graphical interface or graphics window in which the established group chat is running. For example, one of the chat group participants highlights or selects the intended recipient or recipients of a sub-group message using the address bar or participant list in the group chat window. Any suitable method for selecting one or more entries from a list of entries including using a key sequence to signify selection of more than one participant can be used. Having identified the message recipients, the initiating participant enters the message in a message entry box provided in the chat window and dispatches the message to the selected recipients. The message entry box can be the same message entry box used for the group chat or a separate message entry box for just sub-group messaging.

The message is delivered to the identified recipients and displayed on the recipients' computer monitors within the group chat window as a normal chat log line entry. However, an indication is provided to each recipient to indicate that this message is not part of the overall group chat string but is a sub-group or private message. This indication can be used by changing the color, font or appearance, e.g., bold or italics, of the sub-group message or by appending the message with a symbol or text indicating a sub-group or private message. Each message sub-group recipient can select the private message using any suitable point and click type device to establish an ongoing dialog within the sub-group. The ongoing dialogue includes the recipients initially identified and continues to run concurrently with the overall group chat.

Selecting the sub-group of participants and communicating messages just to the selected sub-group is analogous to whispering to one or more individuals during a live, face-to-face presentation. The embedded private chat systems of the present invention can be modified to work with existing chat systems and group chat interfaces. Therefore, for example, if one of the participants opens a separate or new chat window in order to establish a separate, private and concurrent chat with another one of the chat group participants, the recipient receives the private message embedded in the original group chat window, maintaining the appearance of a consolidated chat.

In accordance with one exemplary embodiment, the present invention is directed to a method for whispering in group chats wherein a group chat is established among a plurality of participants. Each participant has an associated computing system, and all of the associated computing systems are in communication across a network. A list of the plurality of group chat participants and a real-time log of group chat message entries are displayed on monitors associated with the computing systems.

A subgroup of the plurality of participants is identified. In one embodiment, the displayed list of group chat participants is used to identify the subgroup. Alternatively, the names of the subgroup participants and an alpha-numeric designation are entered into the log of group chat message entries before entering the private message. Having identified the members of the private chat, a private message is entered on the computing system associated with one member of the identified subgroup of participants, i.e., the originating participant. This message can be entered using a private chat message box displayed on the computing system monitor. Alternatively, the private message is entered in the log of group chat message entries. The entered private message is then delivered to the computing systems associated with all other members of the identified subgroup of participants. The delivered private message is displayed during the group chat only in the real-time log of group chat message entries on the monitors associated with the subgroup of participants. In order to identify the message as a private message, at least one of the font, color, size and appearance of the private message is modified in the log of group chat message entries. Alternatively, an alpha-numeric indication of the private message is displayed.

In one embodiment, the log of group chat message entries and the list of group chat participants are displayed in a group chat window, and the group chat window includes a selectable private chat mode box to place the group chat window in private chat mode and a selectable group chat mode box to place the group chat window in a group chat mode. In one embodiment, the appearance of the group chat window is changed in response to the group chat window being in either the private chat mode or the group chat mode. In one embodiment, a plurality of subgroups of the plurality of participants is displayed, and identification of a subgroup includes selecting one of the displayed plurality of subgroups.

### BRIEF DESCRIPTION OF THE DRAWINGS

FIG. 1 is a schematic representation of an embodiment of a network computing system for use in a combination group and private chat in accordance with the present invention; and

FIG. 2 is a schematic representation of an embodiment of a group chat window displayed on a computing system monitor in accordance with the present invention.

### DETAILED DESCRIPTION

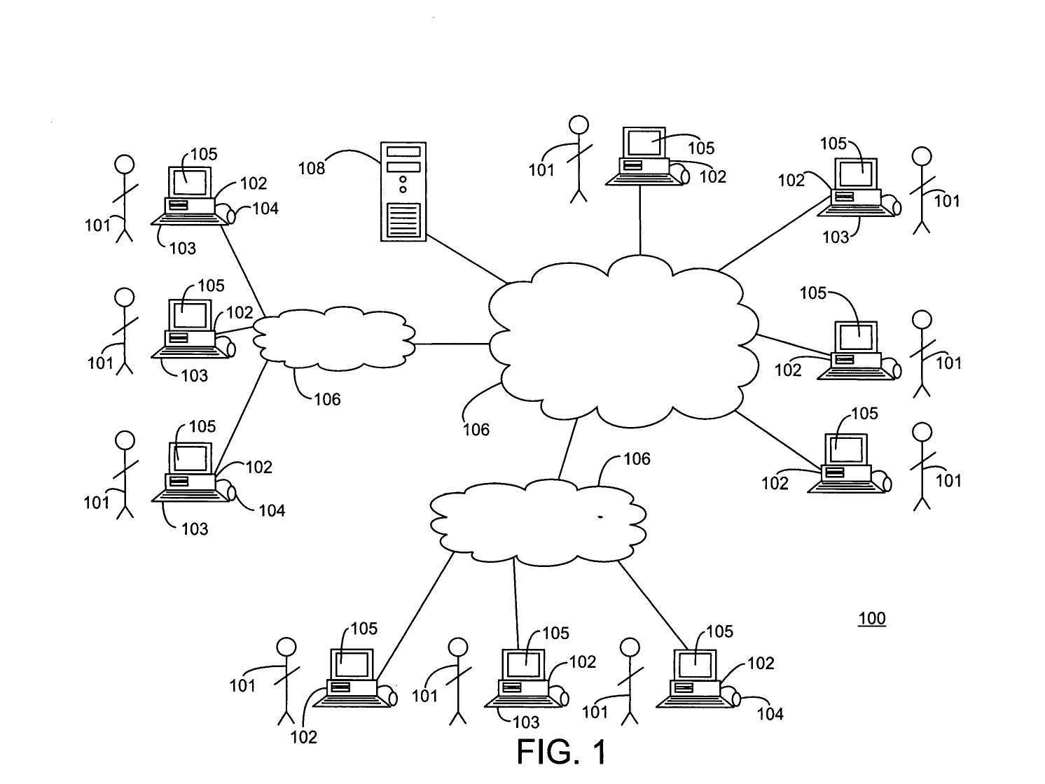

Referring initially to FIG. 1, an embodiment of a system 100 for providing a combination public and private group chat among a plurality of participants in accordance with the present invention is illustrated. Upon establishment of a group chat, i.e., the public group chat, the system 100 includes a plurality of participants 101. Associated with each participant 101 is a computing system 102. Suitable computing systems are known and available in the art and include any system with suitable processor, storage and networking capacity to process the necessary functions of a group chat at each participant, for example, desk top computers, laptop computers, mainframe computers, servers, personal digital assistants and cellular phones. Each computing system includes suitable input and output devices including a keypad or keyboard 103, a point-and-click input device such as a computer mouse 104 and a monitor 105. The computing systems are in communication with each other across one or more networks 106 including wide area networks, local area networks, secure area networks and virtual private networks, among others.

In one embodiment, the group chat utilizes a chat server 108 that is in communication with each computing system 102 across the networks 106. The chat server facilitates and controls the group chat. Alternatively, the group chat functions are provided by one of the computing systems. A given group chat involves a plurality of participants located anywhere in an interconnected topology that includes local area networks, wide area networks, the internet and the intranet. Each participant, for example, when connected to the chat server 108 using appropriate software, converses or chats simultaneously with all of the other concurrent participants in the group using a program dialogue box or window that is displayed on the monitor attached to the computing system associated with that participant. This can be a peer-to-peer chat or a more structured presentation where one of the participants acts as a presenter and provides most of the chat messages. In general, the chats are computer based simulations of real-world or face to face chats.

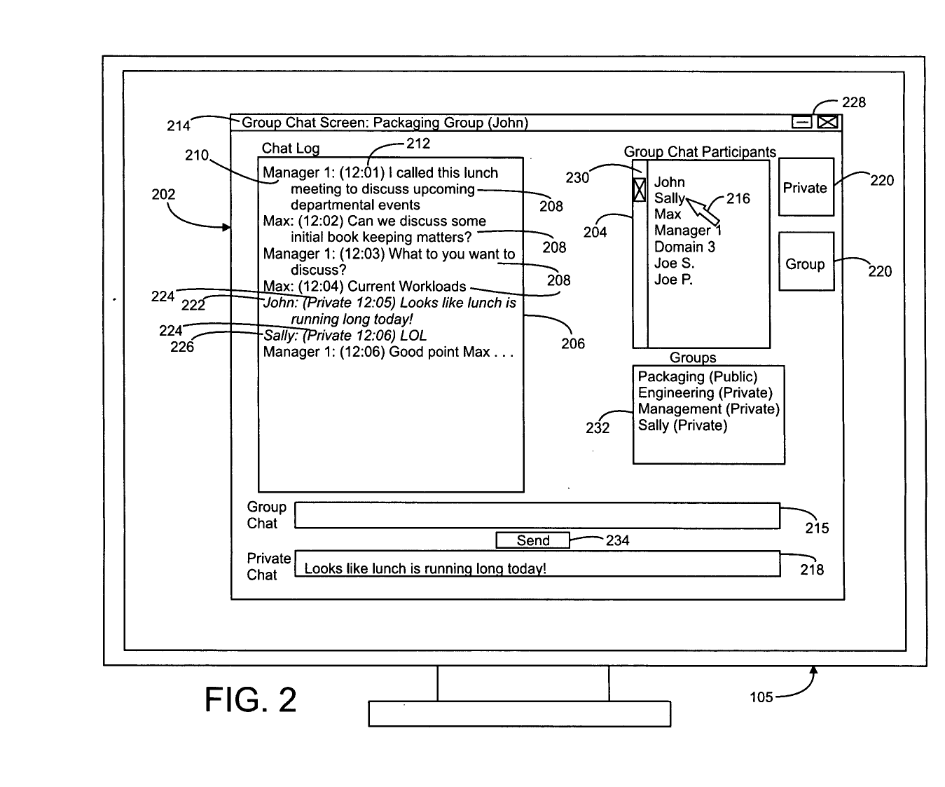

Referring to FIG. 2, an exemplary embodiment of a group chat screen 202 or group chat window that is displayed on each participant's monitor 105 is illustrated. In one embodiment, a typical windows-type chat screen is used; however, any suitable graphical interface for displaying the necessary information for the group chat can be used. In order to facilitate participant interaction with the group chat, at least a list of the plurality of group chat participants 204 and a real-time log of group chat entries 206 are displayed on each participant's monitor. The list of participants includes the names or aliases of all current participants in the group chat. Each participant has the same list of participant names displayed on that participant's monitor. The chat log displays a chronological list of group messages 208 that are entered by any group chat participant. The messages are displayed on all group chat participant monitors including the participant that originates or enters a given message. In addition to the text of the message, each message includes identifying information including an identification of the originating or authoring participant 210 and other information such as a time stamp 212. A participant enters message text either directly into the chat log or into a group chat message entry box or line 214 provided in the group chat window 202.

The group chat window can also include an identification line 216 or header to identify the participant and if desired an identification of the current chat group, e.g., Packaging Group. The group chat window can also include buttons that provide for general windows functions, i.e., close and minimize 228 or scroll bars 230, and group chat specific functions, e.g., a send button 234 to send a message entry to other participants, as desired. In one embodiment, a group chat message entry box 215 is provided to enter messages that are to be delivered to the entire group of participants. Alternatively, message text can be entered directly in the chat log, for example, by “clicking” in the chat log following the last message entry with a windows-based pointing device. In one embodiment, the group chat window and the various boxes within the group chat window include scroll bars for moving within lists or along lines of text as would be understood by one of skill in the art.

Systems and methods in accordance with the present invention provide for one or more private chats or whispers to be conducted within a single group chat window or single group chat interface, concurrent with the group chat. Each private chat involves a subset of the group chat participants. The number of the participants in a private chat subset can range from two participants up to any number below the total number of group chat participants. A private chat can be initiated by any participant in the group chat without pre-approval or authorization from any other participant. In one embodiment, one of the participants selects one or more participants from the list of group chat participants to receive a private message. Suitable methods for selecting members of a list within a windows graphical interface are known and available in the art and include using a pointing device driven cursor 216. Multiple names can be selected, for example, using methods such as holding the “CTRL” key while selecting subsequent names from the list of group chat participants. The selected names will be highlighted within the list using, for example, contrasting colors or font changes.

Having identified the subset of participants from the list of group chat participants, the originating participant enters a message to be delivered to just the identified subset of participants. In one embodiment, this message is entered into a private chat box 218 located within the group chat window. The message is sent by hitting the “ENTER” key on a keyboard or selecting the send button 234 within the group chat window. Alternatively, the private message can be entered into the same box as the group chat message log. In one embodiment, the group chat window is placed in either a private chat or group chat mode by selecting the appropriate button 220 in the group chat window. To indicate the currently selected mode, the color of the group chat window can be changed, and a heading indicating the current chat mode, i.e., public or private, can be displayed within the group chat window. In another embodiment, the private message can be entered directly in the chat log. The private nature of the entered message can be indicated using a leading syntax, for example the word “private” or a symbol such as “!” or “$” typed before the message or displayed before the name associated with the message, e.g. “!John” or “John!”. In one embodiment, the originating participant would begin a private message by typing a leading character followed by the name of the participant to receive the private message, e.g., “!Sally”.

The private message entered on the computing system of the originating participant is delivered to the computing systems of all of the identified members in the subset of participants. The delivered message is then displayed 222 in the chat logs and only the chat logs of the group chat windows of the other members of the subset of participants. The private message also appears on the chat log of the originating participant. The private message does not appear in the chat logs of the group chat participants that were not selected to be part of the private chat. The private message appears in the chat log intermixed or embedded within the group chat messages. Sending the private messages does not prevent or inhibit the delivery of the group chat messages to the private chat participants. The private message 222 also includes an identification of the originating participant and, if desired, a time stamp. Private messages are displayed so as to visually indicate that these messages are private. This visual indication can be an alpha-numeric indication 224 such as the word “Private” or a leading character such as “!” or “$”. In addition, the color, font or effects, e.g., italics, of the private message can be changed. In one embodiment, the private message includes the name of the originating participant and an associated character indicating that the message is private, e.g., “!John”. The various effects used to indicate a private message can be combined to provide increased recognition of private messages.

The private message is displayed on the monitors of all of the private chat participants without the recipients having to accept the message or accept an ongoing private chat with the sending participant. However, the recipient participants do not have to respond or to participate in the private subgroup chat. In one embodiment, if one of the members of the group chat wants to respond to the private message, the responding member of the subset of participants can select the private message, for example, using a single or double click with a point and click type device within the chat log, and can then type in a private message response 226. As with the original private message this message with be sent to all members of the private message participant subset and will be displayed in the chat logs of all those members. A responding member can use all of the same methods including a separate private chat box 218, a private or public chat selection button 220 or the chat log line entry to enter a private chat message. In addition, any given recipient of a private chat message can initiate a new private chat, for example, with just a single member of the original subset of participants. Therefore, the private chat functionalities are the same for all participants in the private chat.

In one embodiment, by selecting a private chat line from the chat log, all of the participants in that private chat are displayed. A list of the subset of group participants can be displayed by highlighting the subset of participants in the list of group chat participants or by displaying the subset of participants in a text bubble or text line that appears when a cursor is placed over a private text message. Any given participant can participate simultaneously in the original overall group chat and in one or more private chats, moving among the various chats as desired. Displaying all chat entries, both private and public, in a single chat log, facilitates this simultaneous participation. In one embodiment, a list of the current or available public and private chat groups 232 is maintained and displayed in a given participant's group chat window. Therefore, that participate can select an established private group to receive a private message at any time during the group chat. If desired, the private group participant subsets can be saved and can survive the termination of the current group chat for use in future group chats, for example with the same group. Participant subset groups can also be identified by category, for example, Freshman, trainees or temporary employees.

In one embodiment, where a participant of the group chat opens a new chat window to establish a chat with a subset of the participants, systems and methods in accordance with the present invention automatically establish this new private chat within the existing group chat windows of the other participants in the private chat subset of participants. Therefore, the other members are not presented with pop-up windows. In addition, the private messages even appear in the existing group chat log of the originating participant. This serves as a reminder to the originating participant of the private chat functionality within the existing group chat window. The originating participant can then close the second chat window and continue with the private chat in the original group chat window. Systems and methods in accordance with the present invention are not limited to the depiction of dialogs as generally stated herein. In one embodiment, group, i.e. public, and private chat windows are consolidated using tabbed menus.

Systems and methods in accordance with the present invention are not restricted to specific key sequence or message entry mechanism and apply to customization settings and other arrangements that signify the directing of a private chat message. In one embodiment, the present invention is implemented and run on a general-purpose computer or computer system. The computer system may be any type of known computing system and may typically include a processor, memory device, a storage device, input/output devices, internal buses and a communications interface for communicating with other computer systems in conjunction with communication hardware and software. As used herein, the terms “computer system” and “computer network” include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktops, laptops, and servers.

Methods and systems in accordance with exemplary embodiments of the present invention can take the form of an entirely hardware embodiment, an entirely software embodiment or an embodiment containing both hardware and software elements. In a preferred embodiment, the invention is implemented in software, which includes but is not limited to firmware, resident software and microcode. In addition, exemplary methods and systems can take the form of a computer program product accessible from a computer-usable or computer-readable medium providing program code for use by or in connection with a computer, logical processing unit or any instruction execution system. For the purposes of this description, a computer-usable or computer-readable medium can be any apparatus that can contain, store, communicate, propagate, or transport the program for use by or in connection with the instruction execution system, apparatus, or device. Suitable computer-usable or computer readable mediums include, but are not limited to, electronic, magnetic, optical, electromagnetic, infrared, or semiconductor systems (or apparatuses or devices) or propagation mediums. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

Suitable data processing systems for storing and/or executing program code include, but are not limited to, at least one processor coupled directly or indirectly to memory elements through a system bus. The memory elements include local memory employed during actual execution of the program code, bulk storage, and cache memories, which provide temporary storage of at least some program code in order to reduce the number of times code must be retrieved from bulk storage during execution. Input/output or I/O devices, including but not limited to keyboards, displays and pointing devices, can be coupled to the system either directly or through intervening I/O controllers. Exemplary embodiments of the methods and systems in accordance with the present invention also include network adapters coupled to the system to enable the data processing system to become coupled to other data processing systems or remote printers or storage devices through intervening private or public networks. Suitable currently available types of network adapters include, but are not limited to, modems, cable modems, DSL modems, Ethernet cards and combinations thereof.

In one embodiment, the present invention is directed to a machine-readable or computer-readable medium containing a machine-executable or computer-executable code that when read by a machine or computer causes the machine or computer to perform a method for whispering in group chats in accordance with exemplary embodiments of the present invention and to the computer-executable code itself. The machine-readable or computer-readable code can be any type of code or language capable of being read and executed by the machine or computer and can be expressed in any suitable language or syntax known and available in the art including machine languages, assembler languages, higher level languages, object oriented languages and scripting languages. The computer-executable code can be stored on any suitable storage medium or database, including databases disposed within, in communication with and accessible by computer networks utilized by systems in accordance with the present invention and can be executed on any suitable hardware platform as are known and available in the art including the control systems used to control the presentations of the present invention.

While it is apparent that the illustrative embodiments of the invention disclosed herein fulfill the objectives of the present invention, it is appreciated that numerous modifications and other embodiments may be devised by those skilled in the art. Additionally, feature(s) and/or element(s) from any embodiment may be used singly or in combination with other embodiment(s) and steps or elements from methods in accordance with the present invention can be executed or performed in any suitable order. Therefore, it will be understood that the appended claims are intended to cover all such modifications and embodiments, which would come within the spirit and scope of the present invention.

What is claimed is:

1. A method for whispering in group chats, the method comprising:
establishing a group chat among a plurality of participants, each participant having an associated computing system, all of the associated computing systems in communication across a network;
displaying a list of the plurality of group chat participants and a real-time log of group chat message entries on monitors associated with the computing systems;
identifying a subgroup of the plurality of participants;
entering a private message on the computing system associated with one member of the identified subgroup of participants;
delivering the entered private message to the computing systems associated with all other members of the identified subgroup of participants; and
displaying the delivered private message during the group chat only in the real-time log of group chat message entries on the monitors associated with the subgroup of participants.

2. The method of claim 1, wherein the step of identifying the subgroup of the plurality of participants further comprises using the displayed list of group chat participants to identify the subgroup.

3. The method of claim 1, wherein the step of identifying the subgroup of the plurality of participants further comprises entering the names of the subgroup participants and an alpha-numeric designation into the log of group chat message entries before entering the private message.

4. The method of claim 1, wherein the step of entering the private message further comprises using a private chat message box displayed on the computing system monitor.

5. The method of claim 1, wherein the step of entering the private message further comprises entering the private message in the log of group chat message entries.

6. The method of claim 1, wherein the step of displaying the delivered private message further comprises modifying at least one of the font, color, size and appearance of the private message in the log of group chat message entries.

7. The method of claim 1, wherein the step of displaying the delivered private message further comprises displaying an alpha-numeric indication of the private message.

8. The method of claim 1, wherein the step of displaying the log of group chat message entries and the list of group chat participants further comprises displaying in a group chat window, and the method further comprises displaying in the group chat window a selectable private chat mode box to place the group chat window in private chat mode and a selectable group chat mode box to place the group chat window in a group chat mode.

9. The method of claim 8, further comprising changing an appearance of the group chat window in response to the group chat window being in either the private chat mode or the group chat mode.

10. The method of claim 1, wherein the method further comprises displaying a plurality of subgroups of the plurality of participants and the step of identifying a subgroup further comprises selecting one of the displayed plurality of subgroups.

11. A computer-readable medium containing a computer-readable code that when read by a computer causes the computer to perform a method for whispering in group chats, the method comprising:
establishing a group chat among a plurality of participants, each participant having an associated computing system, all of the associated computing systems in communication across a network;
displaying a list of the plurality of group chat participants and a real-time log of group chat message entries on monitors associated with the computing systems;
identifying a subgroup of the plurality of participants;
entering a private message on the computing system associated with one member of the identified subgroup of participants;
delivering the entered private message to the computing systems associated with all other members of the identified subgroup of participants; and
displaying the delivered private message during the group chat only in the real-time log of group chat message entries on the monitors associated with the subgroup of participants.

12. The computer-readable medium of claim 11, wherein the step of identifying the subgroup of the plurality of participants further comprises using the displayed list of group chat participants to identify the subgroup.

13. The computer-readable medium of claim 11, wherein the step of identifying the subgroup of the plurality of participants further comprises entering the names of the subgroup participants and an alpha-numeric designation into the log of group chat message entries before entering the private message.

14. The computer-readable medium of claim 11, wherein the step of entering the private message further comprises using a private chat message box displayed on the computing system monitor.

15. The computer-readable medium of claim 11, wherein the step of entering the private message further comprises entering the private message in the log of group chat message entries.

16. The computer-readable medium of claim 11, wherein the step of displaying the delivered private message further comprises modifying at least one of the font, color, size and appearance of the private message in the log of group chat message entries.

17. The computer-readable medium of claim 11, wherein the step of displaying the delivered private message further comprises displaying an alpha-numeric indication of the private message.

18. The computer-readable medium of claim 11, wherein the step of displaying the log of group chat message entries and the list of group chat participants further comprises displaying in a group chat window, and the method further comprises displaying in the group chat window a selectable private chat mode box to place the group chat window in private chat mode and a selectable group chat mode box to place the group chat window in a group chat mode.

19. The computer-readable medium of claim 18, wherein the method further comprises changing an appearance of the group chat window in response to the group chat window being in either the private chat mode or the group chat mode.

20. The computer-readable medium of claim 11, wherein the method further comprises displaying a plurality of subgroups of the plurality of participants and the step of identifying a subgroup further comprises selecting one of the displayed plurality of subgroups.
